(19) United States
(12) Patent Application Publication
(10) Pub. No.: US 2026/0280168 A1
(43) Pub. Date: Sep. 17, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Akihiro NISHITANI, Mie (JP)

(21) Appl. No.: 18/871,483

(22) PCT Filed: May 17, 2023
(86) PCT No.: PCT/JP2023/018366

§ 371 Date: Dec. 4, 2024

(30) Foreign Application Priority Data
Jun. 7, 2022 (JP) 2022-092022

(51) Int. Cl. H01R 12/77; H01R 12/59; H01R 12/67; H01R 12/70; H01R 13/52

(52) U.S. Cl. CPC H01R 12/772; H01R 12/592; H01R 12/67; H01R 12/707; H01R 12/777; H01R 13/5213

(57) ABSTRACT

A connector includes a housing, a plurality of terminal fittings to be positioned by being accommodated into the housing, a flexible cable to which connecting parts of the terminal fittings are soldered, and a reinforcement plate bonded to one plate surface of the flexible cable. The flexible cable is formed with through holes penetrating in a plate thickness direction. The connecting parts of the terminal fittings are inserted into the through holes from the side of the one plate surface and soldered to soldering surfaces provided on another plate surface of the flexible cable. The reinforcement plate is formed with a positioning hole penetrating in the plate thickness direction. The housing includes a boss pin to be inserted into the positioning hole. The positioning hole is closed by the one plate surface of the flexible cable.

### TECHNICAL FIELD

The present disclosure relates to a connector.

### BACKGROUND

Patent Document 1 discloses a configuration for mounting a housing for accommodating terminals made of metal on a circuit body constituted by a flexible printed circuits (FPC) board after a plurality of the terminals are inserted through through holes formed in the circuit body and soldering the respective terminals and the circuit body. In the configuration of Patent Document 1, an extension direction of the terminals is parallel to a plate thickness direction of the circuit body (i.e. the extension direction of the terminals is orthogonal to an expansion direction of the circuit body).

### PRIOR ART DOCUMENT

### Patent Document

Patent Document 1: JP 2020-021595 A

### SUMMARY OF THE INVENTION

### Problems to Be Solved

Since the respective terminals are inserted through the through holes and soldered in the configuration of Patent Document 1, there is a concern that the postures of the respective terminals vary. To avoid such a situation, it is considered to solder the respective terminals after the terminals are accommodated into the housing in advance and position this housing with respect to the circuit body. Specifically, it is considered to provide cylindrical projections on the housing and form positioning holes, into which the projections are inserted, in the circuit body. However, in the case of such a configuration, the projections of the housing project toward a pad for soldering on the circuit body. Thus, when the terminals and the circuit body are soldered, the projections projecting toward the pad may be deformed by the heat of molten solder and positioning may become difficult.

If an attempt is made to make the extension direction of the terminals orthogonal to the plate thickness of the circuit body (i.e. the extension direction of the terminals is parallel to the expansion direction of the circuit body) in the configuration of Patent Document 1, it is necessary to provide a step of creasing the circuit body and provide a component for holding the circuit body in a bent state and it is necessary to increase cost and ensure a space for arranging the component.

A first aspect of the present disclosure was completed on the basis of the above situation and aims to provide a connector mountable on a flexible printed circuits board while satisfactorily positioning a housing accommodating terminals.

A second aspect of the present disclosure was completed on the basis of the above situation and aims to provide a connector enabling a pull-out direction of a flexible printed circuits board to be easily set with respect to an extension direction of terminals.

### Means to Solve the Problem

A first aspect of the present disclosure is directed to a connector with a housing, a plurality of terminal fittings to be positioned by being accommodated into the housing, a flexible printed circuits board, connecting parts of the terminal fittings projecting from the housing being soldered to the flexible printed circuits board, and a supporting member bonded to one plate surface of the flexible printed circuits board, the flexible printed circuits board being formed with through holes penetrating in a plate thickness direction, the connecting parts of the terminal fittings being inserted into the through holes from the one plate surface side and soldered to soldering surfaces provided on the other plate surface of the flexible printed circuits board, the supporting member being formed with a positioning hole penetrating in the plate thickness direction, the housing being provided with a boss pin to be inserted into the positioning hole, and the positioning hole being closed by the one plate surface of the flexible printed circuits board.

A second aspect of the present disclosure is directed to a connector with a flexible printed circuits board having a mounting surface facing forward with a plate thickness oriented in a front-back direction, and a housing to be mounted on the mounting surface, the flexible printed circuits board including an extending portion connected to and extending from the mounting surface, and the connector further comprising a guiding portion for bending the extending portion backward of the mounting surface and guiding the extending portion.

### Effect of the Invention

According to the first aspect of the present disclosure, a housing accommodating terminals can be mounted on a flexible printed circuits board while being satisfactorily positioned.

According to the second aspect of the present disclosure, a pull-out direction of a flexible printed circuits board can be easily set with respect to an extension direction of terminals.

### BRIEF DESCRIPTION OF THE DRAWINGS

FIG. 1 is an exploded perspective view of a connector according to an embodiment.

FIG. 2 is a perspective view of a housing.

FIG. 3 is a side view showing a state where terminals are accommodated in the housing.

FIG. 4 is a perspective view of a flexible cable.

FIG. 5 is a front view showing a state where a reinforcement plate is attached to the flexible cable.

FIG. 6 is a section along A-A in FIG. 5.

FIG. 7 is a plan view in section of the connector.

FIG. 8 is a partial enlarged plan view in section of a right welding boss pin inserted through a reinforcement plate-side insertion hole and an insertion hole.

FIG. 9 is a partial enlarged plan view in section of a left welding boss pin inserted through a reinforcement plate-side insertion hole and an insertion hole.

FIG. 10 is a perspective view of an outer cover.

FIG. 11 is a side view in section of the connector.

FIG. 12 is a side view in section of a connector in another embodiment.

### DETAILED DESCRIPTION TO EXECUTE THE INVENTION

### Description of Embodiments of Present Disclosure

First, embodiments of the present disclosure are listed and described.

(1) The connector of the first aspect of the present disclosure is provided with a housing, a plurality of terminal fittings to be positioned by being accommodated into the housing, a flexible printed circuits board, connecting parts of the terminal fittings projecting from the housing being soldered to the flexible printed circuits board, and a supporting member bonded to one plate surface of the flexible printed circuits board. The flexible printed circuits board is formed with through holes penetrating in a plate thickness direction. The connecting parts of the terminal fittings are inserted into the through holes from the one plate surface side and soldered to soldering surfaces provided on the other plate surface of the flexible printed circuits board. The supporting member is formed with a positioning hole penetrating in the plate thickness direction. The housing is provided with a boss pin to be inserted into the positioning hole, and the positioning hole is closed by the one plate surface of the flexible printed circuits board. According to this configuration, since one end of the positioning hole is closed by the one plate surface of the flexible printed circuits board and the boss pin is inserted from the other end side of the positioning hole, the boss pin needs not be exposed on the other plate surface side provided with the soldering surfaces. Thus, the boss pin is hardly exposed to soldering heat when the terminal fittings are soldered to the soldering surfaces, wherefore the deformation of the boss pin can be prevented.

(2) Preferably, in the first aspect of the present disclosure, an outer cover is provided which is mounted on the flexible printed circuits board from the one plate surface side while accommodating the housing in a state mounted on the flexible printed circuits board. According to this configuration, the detachment of the housing from the flexible printed circuits board can be prevented.

(3) Preferably, in the first aspect of the present disclosure, the supporting member and the flexible printed circuits board are formed with insertion holes penetrating in the plate thickness direction of the flexible printed circuits board, and the outer cover includes a welding boss pin to be inserted into the insertion holes, projecting toward the other plate surface side and to be welded to the flexible printed circuits board. According to this configuration, the outer cover can be easily fixed to the flexible printed circuits board after the terminal fittings are soldered.

(4) Preferably, in the first aspect of the present disclosure, a protecting member is provided which covers the soldering surfaces and is locked to the outer cover across the flexible printed circuits board from the other plate surface side. According to this configuration, the soldering surfaces can be protected and the detachment of the outer cover from the flexible printed circuits board can be prevented by locking the outer cover.

(5) Preferably, in the first aspect of the present disclosure, a waterproof member is provided which prevents liquid adhesion to the soldering surfaces by being applied to the soldering surfaces having the connecting parts of the terminal fittings soldered thereto. According to this configuration, liquid adhesion to the soldering surfaces can be reliably prevented.

(6) Preferably, in the first aspect of the present disclosure, the supporting member is plate-like, and the flexible printed circuits board is reinforced by having the supporting member bonded to the one plate surface. According to this configuration, the supporting member can be made multi-functional by giving a function of reinforcing the flexible printed circuits board and a function of positioning the housing, and an increase in the number of components can be suppressed.

(7) The connector of the second aspect of the present disclosure is provided with a flexible printed circuits board having a mounting surface facing forward with a plate thickness oriented in a front-back direction, and a housing to be mounted on the mounting surface. The flexible printed circuits board includes an extending portion connected to and extending from the mounting surface, and the connector is further provided with a guiding portion for bending the extending portion backward of the mounting surface and guiding the extending portion. According to this configuration, the extending portion of the flexible printed circuits board can be bent and guided by the guiding portion.

(8) Preferably, in the second aspect of the present disclosure, an outer cover is provided which is mountable on the flexible printed circuits board with the housing mounted on the flexible printed circuits board, and the guiding portion is integrally provided to the outer cover. According to this configuration, since the extending portion is bent substantially after the housing is mounted on the flexible printed circuits board, a situation where the housing is mounted in a lifted state on the flexible printed circuits board can be avoided.

(9) Preferably, in the second aspect of the present disclosure, a protecting member is provided which is locked to the outer cover from behind across the mounting surface. The guiding portion is preferably adjacent to the protecting member in a direction intersecting the front-back direction with the protecting member locked to the outer cover. The extending portion is preferably pulled out backward from between the guiding portion and the protecting member. The guiding portion is preferably provided with a guiding portion-side contact portion to be contacted by the extending portion. The protecting member is preferably provided with a protecting member-side contact portion to be contacted by the extending portion. The protecting member-side contact portion is preferably located forward of the guiding portion-side contact portion. According to this configuration, a state where the extending portion is in contact with the guiding portion-side contact portion is easily maintained by the protecting member-side contact portion, whereby a backward pull-out direction of the extending portion can be easily stabilized.

### Details of Embodiment of Present Disclosure

### Embodiment

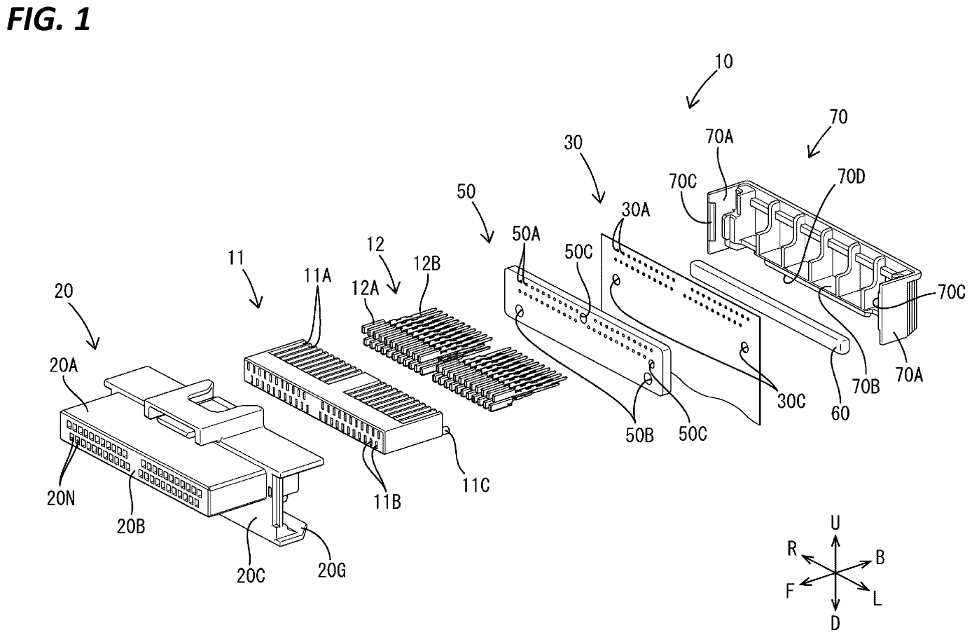

A specific embodiment of a connector 10 of the present disclosure is described below with reference to FIGS. 1 to 11. In figures, a “front side”, a “back side”, an “upper side”, a “lower side”, a “right side” and a “left side” are respectively represented by “F”, “B”, “U”, “D”, “R” and “L”. In this embodiment, a lateral direction corresponds to a width direction.

The connector 10 according to this embodiment is mounted on a flexible cable 30, which is a flexible printed circuits board having a reinforcement plate 50 as a supporting member bonded thereto. The connector 10 is provided with a housing 11, a plurality of terminal fittings 12, the flexible cable 30, the reinforcement plate 50 as the supporting member, an outer cover 20, a guiding portion 20G, a protecting member 70 and a waterproof member 60.

### Housing

The housing 11 is made of synthetic resin. As shown in FIG. 1, the housing 11 is in the form of a block long in the width direction (lateral direction). A plurality of cavities 11A for accommodating the terminal fittings 12 to be described later are formed to penetrate through the inside of the housing 11 in a front-back direction. An opening 11B on the front end of each cavity 11A functions as an insertion hole, into which a mating terminal is inserted.

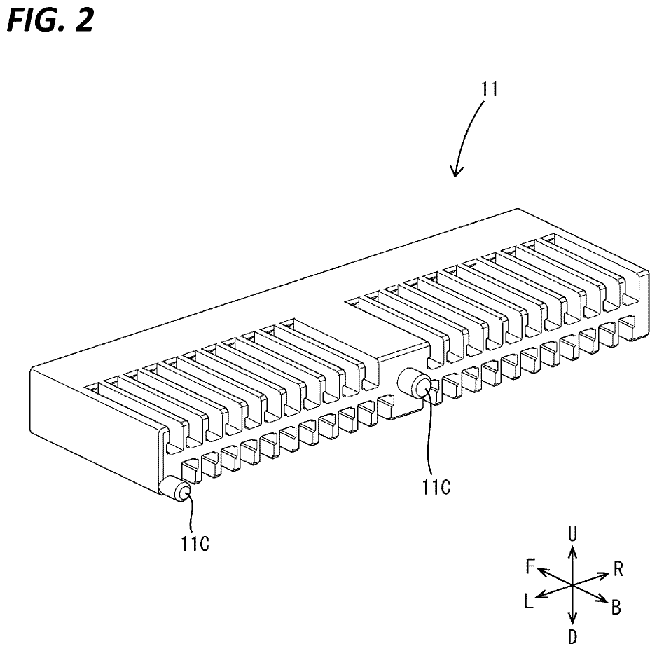

As shown in FIG. 2, a pair of boss pins 11C having a cylindrical shape and extending backward are provided on the back end surface of the housing 11. One boss pin 11C is arranged on a left end part of the housings 11, and the other boss pin 11C is arranged in a lateral central part of the housing 11. An outer diameter of the other boss pin 11C is larger than that of the one boss pin 11C.

### Terminal Fittings

The terminal fitting 12 is formed by bending a metal plate material stamped into a predetermined shape. As shown in FIG. 1, the terminal fitting 12 includes a rectangular tube portion 12A and an inserting portion 12B. The rectangular tube portion 12A is in the form of a rectangular tube extending in the front-back direction and a contact piece (not shown) to be brought into contact with a tab (not shown) of the mating terminal fitting is accommodated inside. The inserting portion 12B is provided in a back end part of the terminal fitting 12. The inserting portion 12B is formed to be elongated backward from the rectangular tube portion 12A.

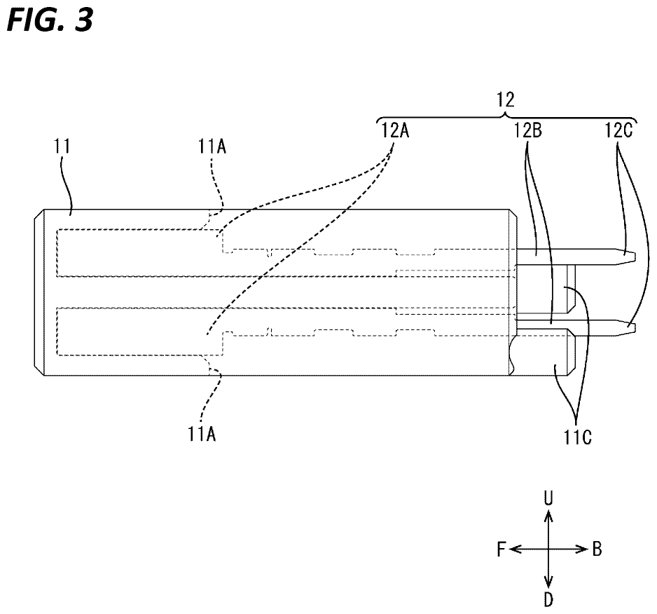

Each terminal fitting 12 is inserted into each cavity 11A of the housing 11 from behind. As shown in FIG. 3, the terminal fitting 12 inserted into each cavity 11A is stopped in front in a front end part of each cavity 11A. The inserting portion 12B of each terminal fitting 12 stopped in front projects further backward than the back end of the housing 11. In each terminal fitting 12, a back end part (tip part) of the inserting portion 12B projecting further backward than the back end of the housing 11 is a connecting part 12C to be soldered to a soldering surface 30A of the flexible cable 30 to be described later. In this way, the plurality of terminal fittings 12 are relatively positioned by being accommodated into the housing 11.

### Flexible Cable

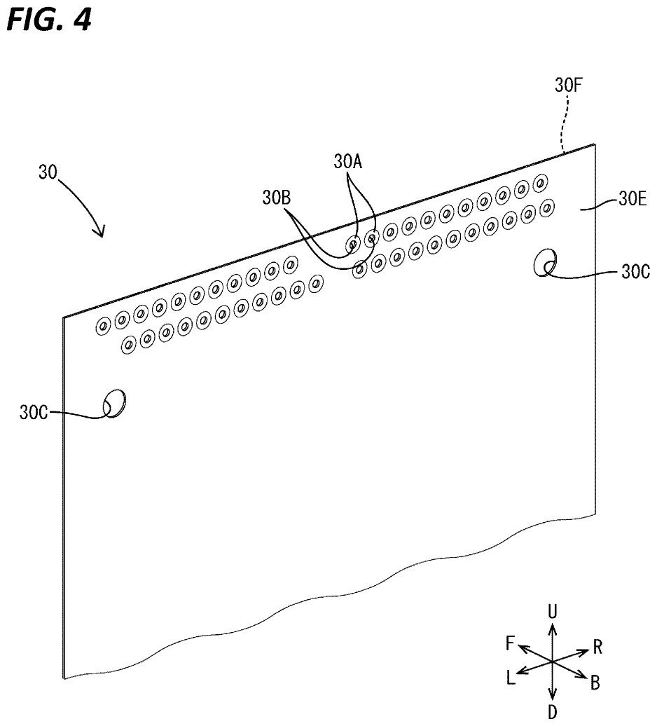

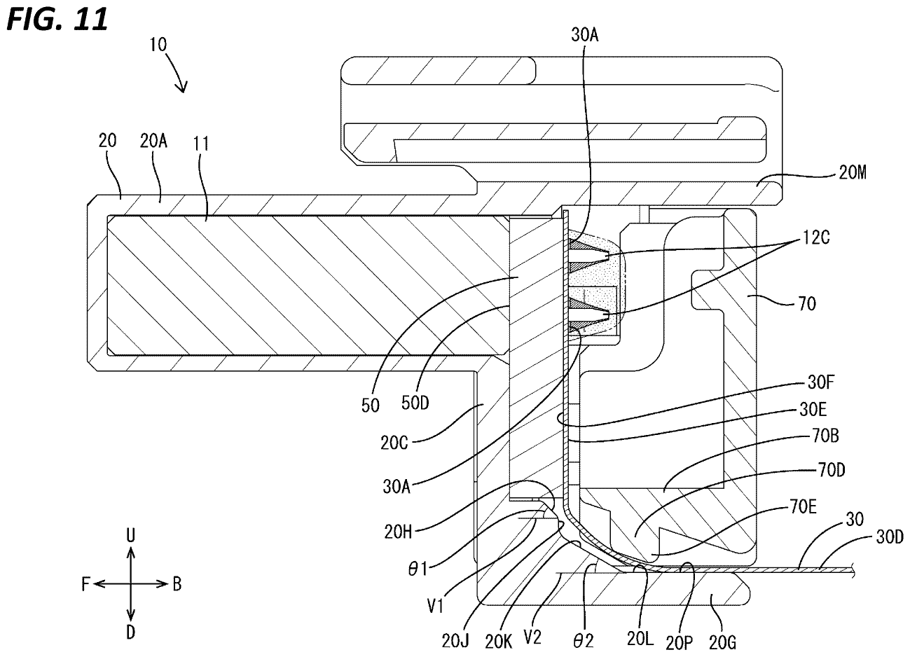

The flexible cable 30 is a cable illustrated as an FFC (Flexible Flat Cable) or FPC and has flexibility (deformability) to be easily deformable upon receiving an external force. The flexible cable 30 is provided with a plurality of unillustrated wiring patterns and in the form of a strip long in the vertical direction with a plate thickness direction oriented in the front-back direction. As shown in FIG. 4, the front surface of the flexible cable 30 is one plate surface 30F and the back surface is another plate surface 30E. End parts of the respective wiring patterns are exposed and formed as a plurality of the soldering surfaces 30A in a tip part of the other plate surface 30E of the flexible cable 30. These soldering surfaces 30A are formed side by side in the width direction (lateral direction). The connecting parts 12C of the terminal fittings 12 are connected to these soldering surfaces 30A by solder (see FIG. 11).

A plurality of through holes 30B and two insertion holes 30C are formed to penetrate through a tip part of the flexible cable 30 in the plate thickness direction. The respective through holes 30B are formed to penetrate through the respective soldering surfaces 30A in the plate thickness direction. That is, the respective through holes 30B are formed at positions corresponding to the respective soldering surfaces 30A.

One of the two insertion holes 30C is arranged in each of both end parts in the width direction (both end parts in the lateral direction) of the strip. The two insertion holes 30C are arranged at positions more distant from the tip of the flexible cable 30 than the plurality of through holes 30B.

### Reinforcement Plate

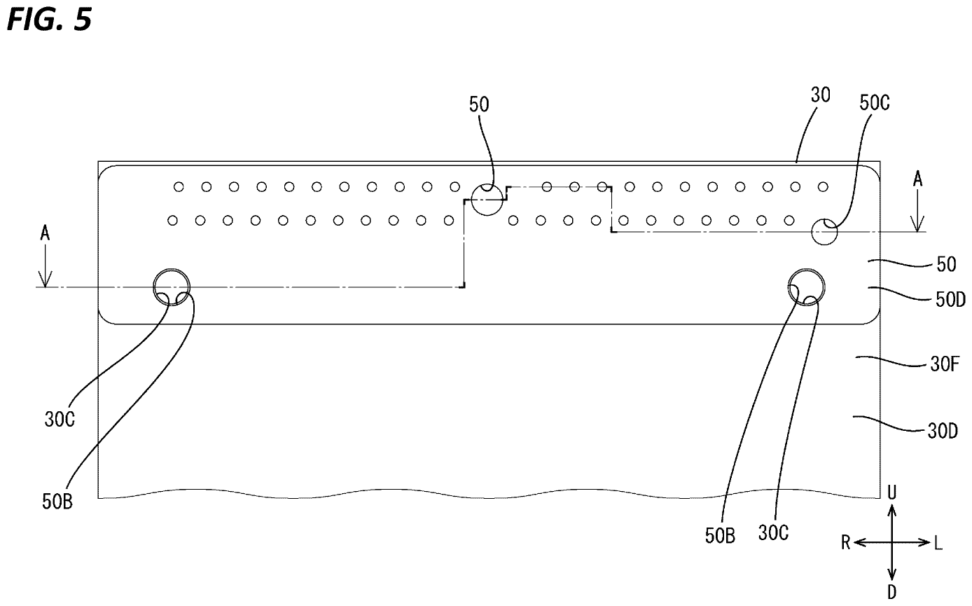

The reinforcement plate 50 is formed into a flat plate shape, using a glass epoxy resin, a polyimide resin or the like. A plate thickness of the reinforcement plate 50 is larger than that of the flexible cable 30. As shown in FIG. 1, a plurality of reinforcement plate-side through holes 50A, which are through holes, two reinforcement plate-side insertion holes 50B, which are insertion holes, and two positioning holes 50C are formed to penetrate through the reinforcement plate 50 in the plate thickness direction. The reinforcement plate-side through holes 50A are arranged to correspond to the plurality of through holes 30B of the flexible cable 30. The two reinforcement plate-side insertion holes 50B are arranged to correspond to the two insertion holes 30C of the flexible cable 30. An inner diameter of the reinforcement plate-side insertion hole 50B is slightly larger than that of the insertion hole 30C (see FIG. 5). One of the two positioning holes 50C is arranged in a left end part of the reinforcement plate 50, and the other is arranged in a lateral central part. An inner diameter of the one positioning hole 50C is smaller than that of the other positioning hole 50C.

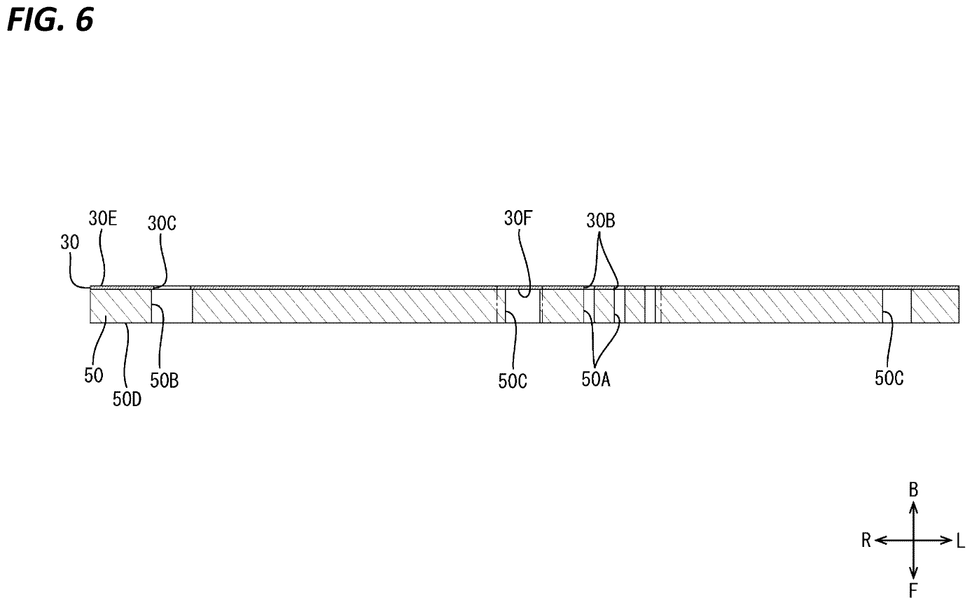

As shown in FIGS. 5 and 6, the reinforcement plate 50 is bonded to the one plate surface 30F in the tip part of the flexible cable 30 using an adhesive. The adhesive is not shown. In this way, the tip part of the flexible cable 30 is reinforced. A surface on a front side of the reinforcement plate 50 bonded to the one plate surface 30F of the flexible cable 30 is a mounting surface 50D forming a part of the one plate surface 30F of the flexible cable 30. In other words, the flexible cable 30 has the mounting surface 50D. The mounting surface 50D is facing forward. The mounting surface 50D is an exposed surface not bonded to the one plate surface 30F of the flexible cable 30. In the flexible cable 30, a part extending downward from the reinforcement plate 50 is an extending portion 30D (see FIG. 5). The extending portion 30D is connected to the mounting surface 50A and extends downward.

As shown in FIG. 6, the respective reinforcement plate-side through holes 50A communicate with the respective through holes 30B in the reinforcement plate 50 bonded to the one plate surface 30F of the flexible cable 30. The respective reinforcement plate-side insertion holes 50B communicate with the respective insertion holes 30C. The back end (one end) of each positioning hole 50C is closed by the one plate surface 30F of the flexible cable 30.

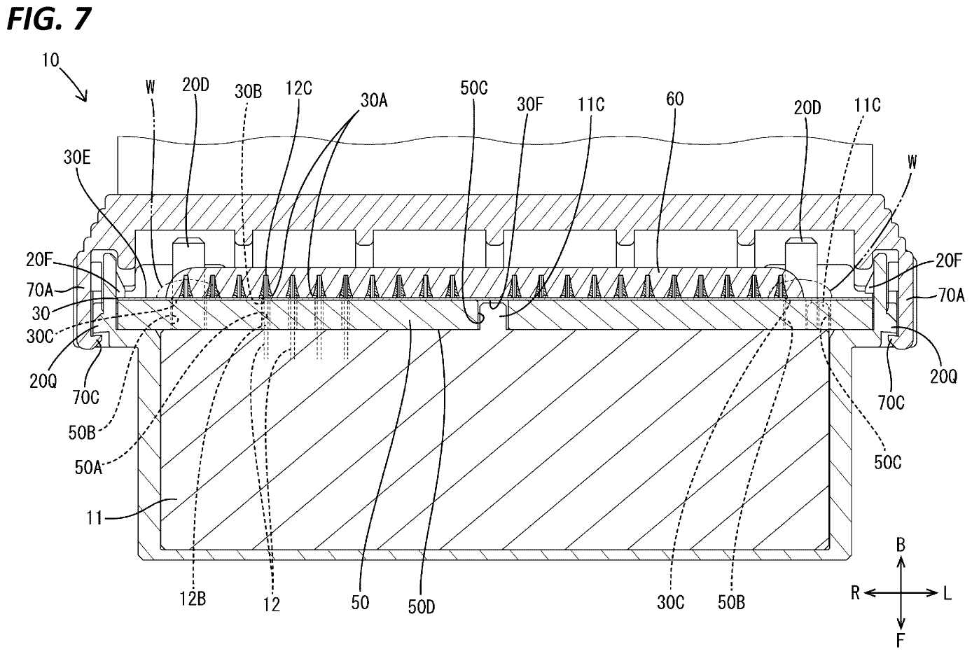

As shown in FIG. 7, the housing 11 having the terminal fittings 12 inserted thereinto is mounted on the mounting surface 50D of the reinforcement plate 50 bonded to the flexible cable 30. Specifically, the connecting parts 12C of the inserting portions 12B of the respective terminal fittings 12 are inserted into the reinforcement plate-side through holes 50A and the through holes 30B from the side of the one plate surface 30F. Along with this, the pair of boss pins 11C are inserted into the positioning holes 50C of the reinforcement plate 50 from the side of the one plate surface 30F. The outer diameter of the boss pin 11C is set to be slightly smaller than that of the positioning hole 50C, into which the boss pin 11C is inserted. When the back end of the housing 11 contacts the mounting surface 50D of the reinforcement plate 50, the mounting of the housing 11 on the reinforcement plate 50 is completed.

With the back end of the housing 11 held in contact with the front surface (mounting surface 50D) of the reinforcement plate 50, the pair of boss pins 11C are accommodated in the positioning holes 50C. The connecting parts 12C of the inserting portions 12B of the respective terminal fittings 12 project further backward than the other plate surface 30E of the flexible cable 30. In this state, the connecting parts 12C are soldered to the soldering surfaces 30A provided on the other plate surface 30E of the flexible cable 30. The pair of boss pins 11C are accommodated in the positioning holes 50 and not exposed on the side of the other plate surface 30E of the flexible cable 30. Thus, the pair of boss pins 11C are not exposed to the heat of the molten solder and a function thereof to position the housing 11 with respect to the flexible cable 30 is not impaired.

### Outer Cover

The outer cover 20 is made of synthetic resin. As shown in FIG. 1, the outer cover 20 includes a cover body portion 20A for accommodating the housing 11 inserted from front and a covering portion 20C for covering the reinforcement plate 50.

The cover body portion 20A is in the form of a rectangular tube extending backward from the outer peripheral edge of a front wall 20B having a plate thickness direction oriented in the front-back direction. The front wall 20B is formed with a plurality of tab insertion holes 20N corresponding to the respective cavities of the housing 11 and penetrating in the plate thickness direction (front-back direction) of the front wall 20B.

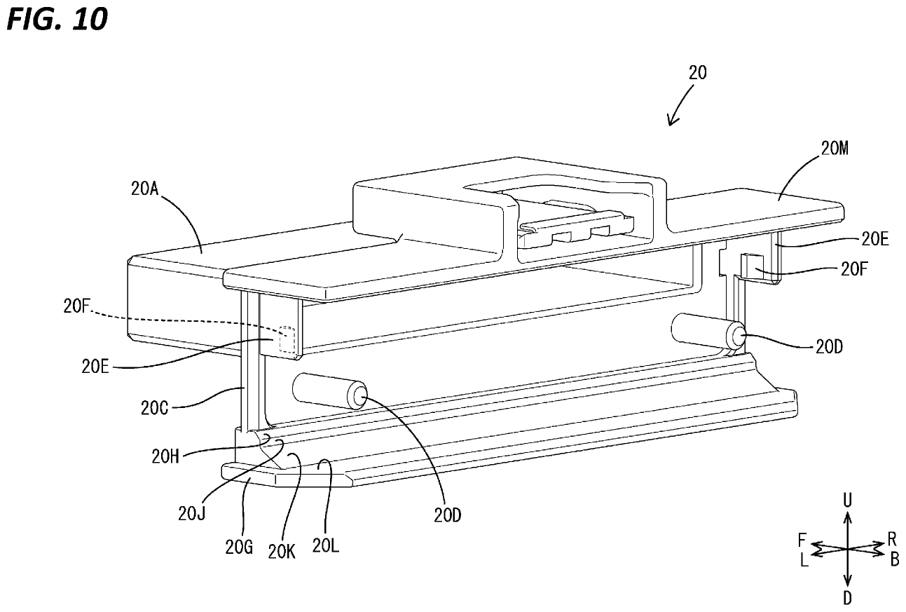

The covering portion 20C is formed to protrude in a direction orthogonal to the front-back direction from a back end part of the cover body portion 20A. As shown in FIG. 10, the covering portion 20C includes an upper wall portion 20M, two welding boss pins 20D and two claw portions 20F. The upper wall portion 20M is in the form of a flat plate and provided to extend backward from an upper end edge extending in the lateral direction in the covering portion 20C. Side wall portions 20E in the form of flat plates and extending downward with a plate thickness direction oriented in the lateral direction are provided on both lateral end parts of the upper wall portion 20M. One claw portion 20F is provided on each side wall portion 20E. These claw portions 20F project laterally inward from laterally inward facing surfaces of the respective side wall portions 20E. The two welding boss pins 20D have a cylindrical shape. One of these welding boss pins 20D is provided on each of both lateral end parts of the covering portion 20C, and extends backward. The welding boss pins 20D are arranged below the cover body portion 20A.

### Guiding Portion

The guiding portion 20G has a function of guiding the extending portion 30D of the flexible cable 30. The guiding portion 20G is integrally coupled to the lower end edge of the covering portion 20C of the outer cover 20 and extends backward. A first inclined surface 20H, a connection surface 20J, a second inclined surface 20K and a parallel surface 20L are successively formed in this order on the upper surface of the guiding portion 20G. The first inclined surface 20H is formed to be continuous with a back side of the lower end edge of the covering portion 20C and inclined downward toward a back side. The connection surface 20J is formed to be continuous with the back end of the first inclined surface 20H and extend downward. The second inclined surface 20K is formed to be continuous with the lower end of the connection surface 20J and inclined downward toward the back side. The parallel surface 20L is formed to be continuous with the back end of the second inclined surface 20K and extend backward in parallel to the front-back direction.

As shown in FIG. 11, an angle θ1 of the first inclined surface 20H to a virtual line V1 extending in the front-back direction is larger than an angle θ2 of the second inclined surface 20K to a virtual line V2 extending in the front-back direction. Here, the virtual lines V1, V2 are parallel. The first and second inclined surfaces 20H and 20K are formed into a step shape via the connection surface 20J.

The outer cover 20 accommodates the housing 11 mounted on the flexible cable 20 and inserted from front, and mounted on the flexible cable 20 from the side of the one plate surface 30F. Specifically, the posture of the outer cover 20 is set such that the guiding portion 20G and the upper wall portion 20M are located behind the cover body portion 20A and the guiding portion 20G is located below the upper wall portion 20M. Then, the cover body portion 20A is brought closer to the housing 11 from front and put on the housing 11. At this time, the extending portion 30D of the flexible cable 30 is pushed backward by the guiding portion 20G and bent backward of the mounting surface 50D. Then, the front surface (mounting surface 50D) of the reinforcement plate 50 is covered by the covering portion 20C.

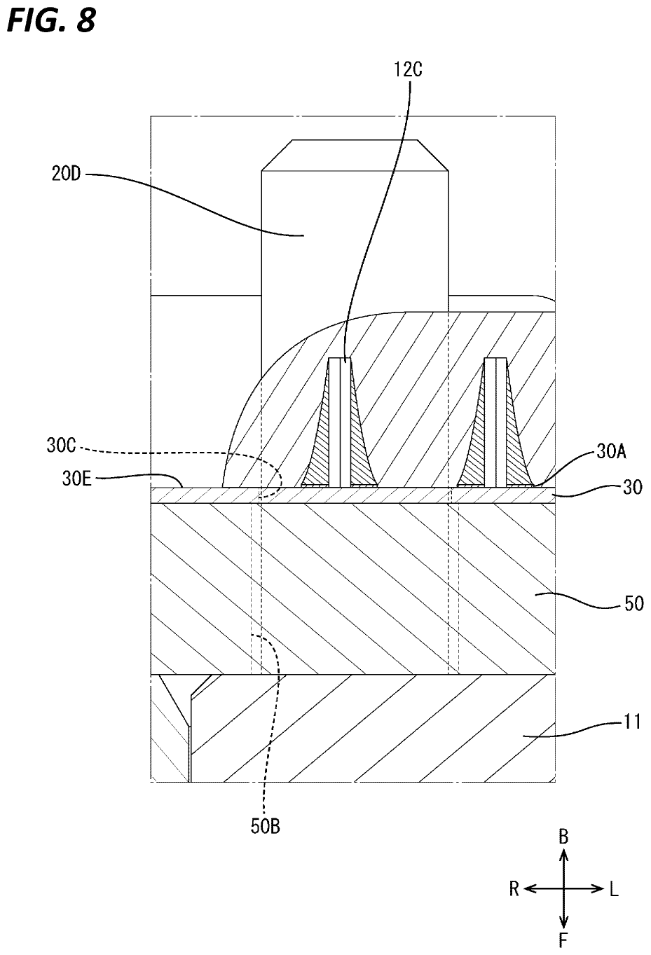

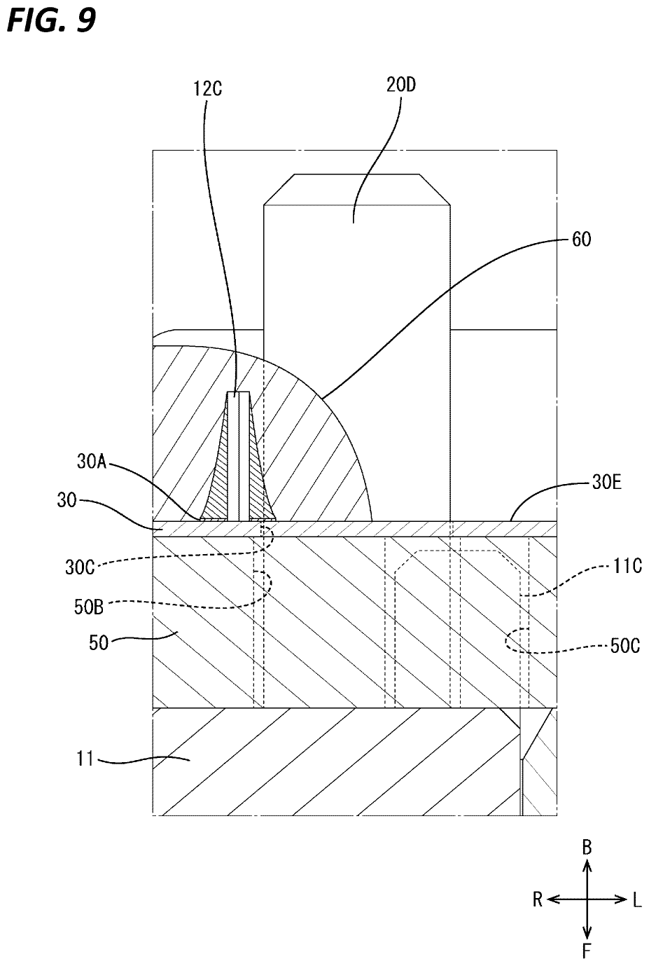

As shown in FIG. 7, the pair of claw portions 20F are respectively locked to both end edges in the lateral direction of the other plate surface 30E of the flexible cable 30. Along with this, the pair of welding boss pins 20D are inserted into the respective reinforcement plate-side insertion holes 50B and the respective insertion holes 30C (see FIGS. 8 and 9), and project toward the other plate surface 30E of the flexible cable 30. The respective welding boss pins 20D projecting toward the other plate surface 30E are deformed into an umbrella shape W by being squeezed while being heated by a welding iron. In this way, the respective welding boss pins 20D are welded to the flexible cable 30.

### Waterproof Member

The waterproof member 60 is, for example, made of synthetic resin such as silicone resin or resin. The waterproof member 60 conceals the soldering surfaces 30A and the connecting parts 12C entirely so as not to expose these. The waterproof member 60 is applied in a fluid state to the soldering surfaces 30A and their peripheries, to which the connecting parts 12C were soldered. The applied waterproof member 60 is cured by irradiating electromagnetic waves such as ultraviolet rays or infrared rays. The cured waterproof member 60 has a function of preventing liquid adhesion to the connecting parts 12C and the soldering surfaces 30A.

### Protecting Member

The protecting member 70 is made of synthetic resin. As shown in FIG. 1, the protecting member 70 is formed to be long in the lateral direction. The protecting member 70 includes a pair of locking wall portions 70A and a guiding wall portion 70B. One of the pair of locking wall portions 70A extends forward from each of the end parts in the lateral direction. A claw portion 70C projecting laterally inward is provided on a front end part of the locking wall portion 70A.

The guiding wall portion 70B has a width in the lateral direction, is continuous with the lower end edge of the protecting member 70 extending in the lateral direction and extends forward. As shown in FIG. 11, the lower surface of the guiding wall portion 70B is formed to be inclined upward toward a front side. A protrusion 70D formed to project downward is provided on a front part of the lower surface of the guiding wall portion 70B. The protrusion 70D is in the form of a rib long in the lateral direction (see FIG. 1). The lower end surface of the protrusion 70 is inclined upward toward the front side.

The protecting member 70 covers the soldering surfaces 30A from behind and is assembled from the side of the other plate surface 30E of the flexible cable 30. The protecting member 70 is inserted into between the guiding portion 20G and the upper wall portion 20M from behind. At this time, the extending portion 30D of the flexible cable 30 is sandwiched by the guiding wall portion 70B and the guiding portion 20G, and the extending portion 30D is pulled out backward from between the guiding wall portion 70B and the guiding portion 20G. The extending portion 30D is located below the guiding wall portion 70B and above the guiding portion 20G.

The respective locking wall portions 70A project further forward than the one plate surface 30F across the flexible cable 30 from the side of the other plate surface 30E, and the respective claw portions 70C are locked to locked portions 20Q formed on the outer cover 20 (see FIG. 7). The respective locking wall portions 70A are locked to the outer cover 20 from behind across the mounting surface 50D (see FIG. 7).

The protrusion 70D of the guiding wall portion 70B contacts the extending portion 30D of the flexible cable 30 bent backward from above. Specifically, the lower end of the protrusion 70D contacts a plate surface connected to the other plate surface 30E provided with the soldering surfaces 30A. The lower end of the protrusion 70D is a protecting member-side contact portion 70E to be contacted by the extending portion 30D. In contrast, the parallel surface 20L of the guiding portion 20G contacts a plate surface connected to the one plate surface 30F having the reinforcement plate 50 bonded thereto. The parallel surface 20L is a guiding portion-side contact portion 20P to be contacted by the extending portion 30D. With the protecting member 70 mounted on the outer cover 20, the protrusion 70D is located forward of the back end of the guiding portion 20G. In other words, with the protecting member 70 mounted on the outer cover 20, the protecting member-side contact portion 70E is located forward of the guiding portion-side contact portion 20P. With the protecting member 70 locked to the outer cover 20, the guiding portion 20G is arranged below (direction intersecting the front-back direction) and adjacent to the protecting member 70.

Next, functions of this embodiment are described.

The connector 10 is provided with the housing 11, the plurality of terminal fittings 12, the flexible cable 30 and the reinforcement plate 50. The plurality of terminal fittings 12 are positioned by being accommodated into the housing 11. The connecting parts 12C of the terminal fittings 12 projecting from the housing 11 are soldered to the flexible cable 30. The reinforcement plate 50 is bonded to the one plate surface 30F of the flexible cable 30. The flexible cable 30 is formed with the through holes 30B penetrating in the plate thickness direction. The connecting part 12C of the terminal fitting 12 is inserted into the through hole 30B from the side of the one plate surface 30F and soldered to the soldering surface 30A provided on the other plate surface 30E of the flexible cable 30. The reinforcement plate 50 is formed with the positioning holes 50C penetrating in the plate thickness direction. The housing 11 is provided with the boss pins 11C to be inserted into the positioning holes 50C, and the back ends of the positioning holes 50C are closed by the one plate surface 30F of the flexible cable 30.

According to this configuration, since one end of the positioning hole 50C is closed by the one plate surface 30F of the flexible cable 30 and the boss pin 11C is inserted from the other end side of the positioning hole 50C, the boss pin 11C needs not be exposed on the side of the other plate surface 30E provided with the soldering surfaces 30A. Thus, when the terminal fittings 12 are soldered to the soldering surfaces 30A, the boss pins 11C are hardly exposed to soldering heat, wherefore the deformation of the boss pins 11C can be prevented.

The connector 10 is provided with the outer cover 20 configured to accommodate the housing 11 in the state mounted on the flexible cable 30 and to be mounted on the flexible cable 30 from the side of the one plate surface 30F. According to this configuration, the detachment of the housing 11 from the flexible cable 30 can be prevented.

In the connector 10, the reinforcement plate 50 is formed with the reinforcement plate-side insertion holes 50B penetrating in the plate thickness direction of the reinforcement plate 50, and the flexible cable 30 is formed with the insertion holes 30C penetrating in the plate thickness direction of the flexible cable 30. The outer cover 20 includes the welding boss pins 20D to be inserted into the reinforcement plate-side insertion holes 50B and the insertion holes 30C, projecting toward the side of the other plate surface 30E and welded to the flexible cable 30. According to this configuration, the outer cover 20 can be easily fixed to the flexible cable 30 after the terminal fittings 12 are soldered.

The connector 10 is provided with the protecting member 70 configured to cover the soldering surfaces 30A and to be locked to the outer cover 20 across the flexible cable 30 from the side of the other plate surface 30E. According to this configuration, the soldering surfaces 30A can be protected and the detachment of the outer cover 20 from the flexible cable 30 can be prevented by locking the outer cover 20.

The connector 10 is provided with the waterproof member 60 for preventing liquid adhesion to the soldering surfaces 30A by being applied to the soldering surfaces 30A, to which the connecting parts 12C of the terminal fittings 12 are soldered. According to this configuration, liquid adhesion to the soldering surfaces 30A can be reliably prevented.

In the connector 10, the reinforcement plate 50 is plate-like. The flexible cable 30 is reinforced by bonding the reinforcement plate 50 to the one plate surface 30F. According to this configuration, the reinforcement plate 50 can be made multi-functional by giving a function of reinforcing the flexible cable 30 and a function of positioning the housing 11, and an increase in the number of components can be suppressed.

The connector 10 is provided with the flexible cable 30 having the mounting surface 50 facing forward with the plate thickness direction oriented in the front-back direction, and the housing 11 to be mounted on the mounting surface 50D. The flexible cable 30 includes the extending portion 30D connected to and extending from the mounting surface 50D. Further, the connector 10 is provided with the guiding portion 20G for bending the extending portion 30D backward of the mounting surface 50D and guiding the extending portion 30D. According to this configuration, the extending portion 30D of the flexible cable 30 can be bent and guided by the guiding portion 20G.

The connector 10 is provided with the outer cover 20 mountable on the flexible cable 30 in the state mounted on the flexible cable 30. The guiding portion 20G is integrally provided to the outer cover 20. According to this configuration, since the extending portion 30D is bent substantially after the housing 11 is mounted on the flexible cable 30, a situation where the housing 11 is mounted in a lifted state on the flexible cable 30 can be avoided.

The connector 10 is provided with the protecting member 70 to be locked to the outer cover 20 from behind across the mounting surface 50D. With the protecting member 70 locked to the outer cover 20, the guiding portion 20G is adjacent to the protecting member 70 in the direction intersecting the front-back direction, and the extending portion 30D is pulled out backward from between the guiding portion 20G and the protecting member 70. The guiding portion 20G is provided with the guiding portion-side contact portion 20P to be contacted by the extending portion 30D, the protecting member 70 is provided with the protecting member-side contact portion 70E to be contacted by the extending portion 30D and the protecting member-side contact portion 70E is located forward of the guiding portion-side contact portion 20P. According to this configuration, a state where the extending portion 30D is in contact with the guiding portion-side contact portion 20P is easily maintained by the protecting member-side contact portion 70E, whereby the backward pull-out direction of the extending portion 30D can be easily stabilized.

### Other Embodiments

The present disclosure is not limited to the above described and illustrated embodiment. The present invention is intended to include all changes in the scope of claims and in the meaning and scope of equivalents and also include the following embodiments.

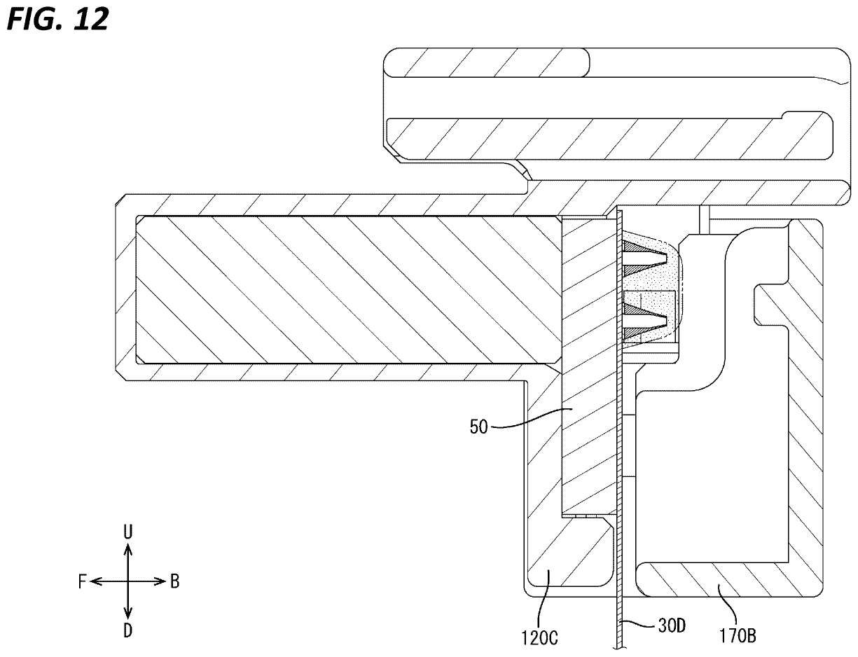

(1) Unlike the above embodiment, the guiding portion may be integrally provided to the housing. In this case, to prevent the housing from being lifted from the flexible cable, the housing is preferably provided with a pair of claw portions to be locked to both end parts in the lateral direction of the tip part of the flexible cable. Further, the guiding portion may not be provided as shown in FIG. 12. In this case, the extending portion 30D is sandwiched in the front-back direction by a guiding wall portion 170B and a covering portion 120C and pulled out downward.

(2) The terminal fittings may be male terminal fittings.

(3) Unlike the above embodiment, the waterproof member may be applied up to a region, where the protecting member is arranged, without providing the protecting member. Further, the protecting member may be mounted without applying the waterproof member.

(4) The positions of the boss pins are not limited to those illustrated in the above embodiment. Further, the respective boss pins may have the same outer diameter.

(5) A supporting member three-dimensionally molded using a synthetic resin may be bonded to the flexible cable.

### LIST OF REFERENCE NUMERALS

10 . . . connector
11 . . . housing
11A . . . cavity
11B . . . opening
11C . . . boss pin
12 . . . terminal fitting
12A . . . rectangular tube portion
12B . . . inserting portion
12C . . . connecting part
20 . . . outer cover
20A . . . cover body portion
20B . . . front wall
20C, 120C . . . covering portion
20D . . . welding boss pin
20E . . . side wall portion
20F . . . claw portion
20G . . . guiding portion
20H . . . first inclined surface
20J . . . connection surface
20K . . . second inclined surface
20L . . . parallel surface
20M . . . upper wall portion
20N . . . tab insertion hole
20P . . . guiding portion-side contact portion
20Q . . . locked portion
30 . . . flexible cable (flexible printed circuits board)
30A . . . soldering surface
30B . . . through hole
30C . . . insertion hole
30D . . . extending portion
30E . . . other plate surface
30F . . . one plate surface
50 . . . reinforcement plate (supporting member)
50A . . . reinforcement plate-side through hole (through hole)
50B . . . reinforcement plate-side insertion hole (insertion hole)
50C . . . positioning hole
50D . . . mounting surface
60 . . . waterproof member
70 . . . protecting member
70A . . . locking wall portion
70B, 170B . . . guiding wall portion
70C . . . claw portion
70D . . . protrusion
70E . . . protecting member-side contact portion
W . . . umbrella shape
V1, V2 . . . virtual line
θ1 . . . angle of first inclined surface to front-back direction
θ2 . . . angle of second inclined surface to front-back direction

1. A connector, comprising:
a housing;
a plurality of terminal fittings to be positioned by being accommodated into the housing;
a flexible printed circuits board, connecting parts of the terminal fittings projecting from the housing being soldered to the flexible printed circuits board; and
a supporting member bonded to one plate surface of the flexible printed circuits board,
the flexible printed circuits board being formed with through holes penetrating in a plate thickness direction,
the connecting parts of the terminal fittings being inserted into the through holes from the one plate surface side and soldered to soldering surfaces provided on the other plate surface of the flexible printed circuits board,
the supporting member being formed with a positioning hole penetrating in the plate thickness direction,
the housing being provided with a boss pin to be inserted into the positioning hole, and
the positioning hole being closed by the one plate surface of the flexible printed circuits board.

1. The connector of claim 1, comprising an outer cover to be mounted on the flexible printed circuits board from the one plate surface side while accommodating the housing in a state mounted on the flexible printed circuits board.

3. The connector of claim 2, wherein:
the supporting member and the flexible printed circuits board are formed with insertion holes penetrating in the plate thickness direction, and
the outer cover includes a welding boss pin to be inserted into the insertion holes, projecting toward the other plate surface side and to be welded to the flexible printed circuits board.

4. The connector of claim 2, comprising a protecting member for covering the soldering surfaces, the protecting member being locked to the outer cover across the flexible printed circuits board from the other plate surface side.

5. The connector of claim 1, comprising a waterproof member for preventing liquid adhesion to the soldering surfaces by being applied to the soldering surfaces having the connecting parts of the terminal fittings soldered thereto.

6. The connector of claim 4, comprising a waterproof member for preventing liquid adhesion to the soldering surfaces by being applied to the soldering surfaces having the connecting parts of the terminal fittings soldered thereto.

7. The connector of claim 1, wherein:
the supporting member is plate-like, and
the flexible printed circuits board is reinforced by having the supporting member bonded to the one plate surface.

8. The connector of claim 4, wherein:
the supporting member is plate-like, and
the flexible printed circuits board is reinforced by having the supporting member bonded to the one plate surface.

9. The connector of claim 5, wherein:
the supporting member is plate-like, and
the flexible printed circuits board is reinforced by having the supporting member bonded to the one plate surface.

10. The connector of claim 6, wherein:
the supporting member is plate-like, and
the flexible printed circuits board is reinforced by having the supporting member bonded to the one plate surface.

11. A connector, comprising:
a flexible printed circuits board having a mounting surface facing forward with a plate thickness oriented in a front-back direction; and
a housing to be mounted on the mounting surface,
the flexible printed circuits board including an extending portion connected to and extending from the mounting surface, and
the connector further comprising a guiding portion for bending the extending portion backward of the mounting surface and guiding the extending portion.

12. The connector of claim 11, comprising an outer cover mountable on the flexible printed circuits board with the housing mounted on the flexible printed circuits board, wherein:
the guiding portion is integrally provided to the outer cover.

13. The connector of claim 12, comprising a protecting member to be locked to the outer cover from behind across the mounting surface, wherein:
the guiding portion is adjacent to the protecting member in a direction intersecting the front-back direction with the protecting member locked to the outer cover,
the extending portion is pulled out backward from between the guiding portion and the protecting member,
the guiding portion is provided with a guiding portion-side contact portion to be contacted by the extending portion,
the protecting member is provided with a protecting member-side contact portion to be contacted by the extending portion, and
the protecting member-side contact portion is located forward of the guiding portion-side contact portion.
